(19) United States
(12) Patent Application Publication
(10) Pub. No.: US 2011/0273535 A1
(43) Pub. Date: Nov. 10, 2011

(54) MOLE MONITORING SYSTEM

(76) Inventor: Avi Mendelson, Hinanit (IL)

(21) Appl. No.: 13/138,208

(22) PCT Filed: Jan. 28, 2009
(86) PCT No.: PCT/IB2009/050348

§ 371 Date: Jul. 20, 2011

(51) Int. Cl. G06K 9/00; H04N 13/00; H04N 7/18

(52) U.S. Cl. 348/43; 382/130; 348/77; 348/E13.074

(57) ABSTRACT

A mole monitoring system comprising an imaging station adapted to record at least two temporally-distinct images of a mole, wherein said imaging station comprises an interface module adapted to transmit said images to a remote storage device; and control logic adapted to retrieve said images from said remote storage device and to compare a parameter across said at least two images of said mole, wherein a difference in the parameter is indicative of the mole being potentially associated with melanoma.

### FIELD OF THE DISCLOSURE

Embodiments of the disclosure relate to a mole monitoring system adapted to facilitate detection of moles potentially associated with melanoma.

### BACKGROUND

Melanoma is a type of skin cancer often expressed by malignant tumors of melanocytes. Around 160,000 new cases of melanoma are diagnosed worldwide each year, more frequently in males and caucasians. (See Ries L A G, et al, eds. SEER Cancer Statistics Review, 1975-2000. Bethesda, Md., National Cancer Institute 2003, incorporated herein by reference.) Melanoma is more common in caucasian populations living in sunny climates than other groups. (See Parkin D, Bray F, Ferlay J & Pisani P., Global cancer statistics, 2002. CA Cancer J Clin 55 (2): 74-108, incorporated herein by reference.) According to a World Health Organization (WHO) report, about 48,000 melanoma-related deaths occur worldwide per year. (See Lucas, R., Global Burden of Disease of Solar Ultraviolet Radiation, Environmental Burden of Disease Series, Jul. 25, 2006; No. 13. News release, World Health Organization, incorporated herein by reference.) Malignant melanoma accounts for 75 percent of all deaths associated with skin cancer. (See Jerant A F, Johnson J T, Sheridan C D & Caffrey T J., Early detection and treatment of skin cancer, Am Fam Physician. 2000 Jul. 15; 62(2), incorporated herein by reference.)

The treatment of melanoma commonly includes surgical removal of the tumor, adjuvant treatment, chemotherapy and immunotherapy, and/or radiation therapy.

Melanoma is commonly diagnosed by an excisional biopsy of suspicious-looking moles, such as those that fit, under a visual and/or a dermatological examination, what is referred to as the classical ABCDE criteria. ABCDE stands for Asymmetry, irregular Borders, irregular Coloration, Diameter of 6 millimeters (mm) or more, and Enlargement (or, in some versions, Evolution). Of these five criteria, only the last one, enlargement, explicitly relates to changes in the mole over time. The rest of the criteria pertain to a current, static state of the mole. (See L. Thomas, P. Tranchand, F. Berard, T. Secchi, C. Colin & G. Moulin, Semiological Value of ABCDE Criteria in the Diagnosis of Cutaneous Pigmented Tumors, Dermatology 1998, 197, pp 11-17, incorporated herein by reference.)

Commonly, the enlargement criterion is determined by the physician based on the patient's recall of the mole's historical size. Naturally, many patients are reluctant to supply their physician with this information and, therefore, actual diagnosis of melanoma based on gradual enlargement of moles is not common.

Still, temporal changes in a mole—and not only changes to its size—are known in the art to be indicative of a progress in the malignant process of the melanocyte tumor. For example, changes to the mole's shape, location, color, texture and/or the like, over a period of time, may be indicative of a developing melanoma.

### SUMMARY

There is provided, according to an embodiment, a method for detecting a mole potentially associated with melanoma, the method comprising comparing a parameter across at least two temporally-distinct images of a mole, wherein a difference in the parameter is indicative of the mole being potentially associated with melanoma.

There is further provided, according to an embodiment, a mole monitoring system, comprising: an imaging station adapted to record at least two temporally-distinct images of a mole, wherein said imaging station comprises an interface module adapted to transmit said images to a remote storage device; and control logic adapted to retrieve said images from said remote storage device and to compare a parameter across said at least two images of said mole, wherein a difference in the parameter is indicative of the mole being potentially associated with melanoma.

There is further provided, according to an embodiment, a comparative mole analyzer, comprising control logic adapted to retrieve at least two temporally-distinct images of a mole and to compare a parameter across said at least two images, wherein a difference in said parameter is indicative of the mole being potentially associated with melanoma.

In some embodiments, the parameter comprises a location of the mole, planar measurements of the mole, a three-dimensional structure of the mole and/or a color of the mole.

In some embodiments, the method further comprises pre-processing at least one of the images.

In some embodiments, the pre-processing comprises concealing hair shown in at least one of the images.

In some embodiments, the pre-processing comprises concealing a light reflection shown in at least one of the images.

In some embodiments, the method further comprises stitching the at least two images.

In some embodiments, the method further comprises creating a three-dimensional model of the mole.

In some embodiments, said imaging station further comprises: a chamber adapted to accommodate a patient; an imaging device adapted to record said at least two temporally-distinct images of said mole; and a control unit.

In some embodiments, said imaging station further comprises an illumination device.

In some embodiments, said system further comprises a body positioning sub-system.

In some embodiments, said control unit is further adapted to pre-process at least one of said images.

In some embodiments, said control logic is further adapted to pre-process at least one of said images.

In some embodiments, said control logic is further adapted to stitch said at least two images.

In some embodiments, said control logic is further adapted to create a three-dimensional model of said mole.

In some embodiments, said remote storage device is adapted to separately store an image of a head and an image of a body, both being part of said at least two temporally-distinct images.

In some embodiments, said system further comprises a second remote storage device adapted to store an image of a head being part of said at least two temporally-distinct images, and wherein said remote storage device is adapted to store an image of a body being part of said at least two temporally-distinct images, so that said images of the body and of the head are stored separately.

In some embodiments, said remote storage device is accessible through a network, to facilitate data retrieval by a user.

In some embodiments, said network is the Internet.

There is further provided, according to an embodiment, an apparatus adapted to monitor a bodybuilding process, the apparatus comprising: an imaging station adapted to accommodate a bodybuilder and to record at least two temporally-distinct images of said bodybuilder; and control logic adapted to compare a muscle size across said at least two images of said mole and to report a change in said muscle size to said bodybuilder.

There is further provided, according to an embodiment, an apparatus adapted to create a three-dimensional model of a human, the apparatus comprising: an imaging station adapted to accommodate a human and to record at least three images of said human; and control logic adapted to create a digital three-dimensional model of said human based on said at least three images.

In some embodiments, said control logic is further adapted to output a digital file comprising said model in a format adapted for use as an avatar in a virtual world.

In some embodiments, said control logic is further adapted to output a digital file comprising said model in a format adapted for use as a clothing model in an online clothing store.

In some embodiments, said apparatus further comprises a laser rangefinder.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a flow chart of an algorithm;

FIGS. 2A-2B each shows a digital image of a mole;

FIGS. 3A-3B each shows a three-dimensional model of a mole;

FIG. 4 shows a network diagram of a mole monitoring system;

FIG. 5 shows a perspective view of a photo booth;

FIG. 6 shows a perspective view of three postures of a patient; and

FIG. 7 shows a perspective view of a three-dimensional model of a human.

### DETAILED DESCRIPTION

An aspect of some embodiments relates to a method, a device and a system for detecting one or more moles that are potentially associated with melanoma. A detected mole may be indicated to the patient and/or to his or her physician, to enable further examination of the detected mole. For example, following a detection, the physician may closely examine the mole and optionally order an excisional biopsy if the examination confirms that the mole is indeed potentially associated with melanoma. The excision itself may, in some scenarios, eliminate the melanoma from progressing altogether.

In an embodiment, one or more parameters may be compared across at least two temporally-distinct images of a mole, wherein a difference in one or more of these parameters is indicative of the mole being potentially associated with melanoma. The parameters may include, for example, the mole's location, its planar measurements, height above the skin, three-dimensional structure, color or the like. Basically, any visually-observable change in the mole over time may be included in the compared parameters.

U.S. Pat. No. 7,415,143 to Grichnik proposes, for detection of melanoma, identifying moles or lesions that are both non-uniform and changed over time. In regard to non-uniformity, Grichnik explains that it is—
“based on the concept that a benign mole or melanoma originates in the skin from a focal defect (this does not exclude the role that systemic factors, genetics, environment, and circulating cells play in melanoma and mole development) [ . . . ] Nonetheless, it is contemplated that this defect is presumed to be a mutated melanocytic cell (precursor cell or melanocyte). For both benign and malignant lesions growth starts focally and then expands outward. Malignant lesions lack tight regulatory controls. Thus, as the lesion grows away from the origin, the cells may change their behavior (e.g., due to, but not limited to, additional mutations or changes in cellular differentiation). The relative independence of the malignant cells allows for cells expanding in one area of the lesion to demonstrate features different from cells on the other side (or other part) of the lesion. This may be due to, but not limited to, altered rates of pigment production, altered types of pigment, altered growth rates, altered locations of growth, and different clones of cells (survival of the fittest).”

Grichnik further describes a clinical trial in which “no nonuniform and changing lesion was left on a patient”, namely—he suggests performing excisional biopsy on lesions being both changed over time and nonuniform, wherein existence of only one of these parameters is insufficient:
“Nonetheless, it is contemplated that lesions with severe atypia could also include some early malignant lesions that have not yet sufficiently evolved. If the outcome of interest was defined as having severe melanoma or dysplastic nevi with severe atypia, the OR comparing lesions scored as nonuniform and changed with lesions scored otherwise was 2.56 (P=0.0097, 95% CI 1.26-5.25) and 5.08 (P=0.0001, 95% CI 2.30-11.18) for 2 out of 3 and 3 out of 3 agreement, respectively.

The majority of the lesions in the study set were graded as changed (Table II). For the lesions graded as changed (at least 2/3 agreement), there was a clear segregation of the melanomas to the nonuniform subgroup of 80% (12/15). This included 100% (5/5) of the invasive melanomas and 70% (7/10) of the in situ melanomas. To a lesser extent 65% (15/23) of dysplastic nevi with severe atypia also segregated to the nonuniform subgroup. Among the changed benign nevi (dysplastic moderate, mild, and other), there was a relatively even split between those graded as uniform at 48% (47/97) and those graded as nonuniform at 52% (50/97).

TABLE 11
Lesion distribution for at least two out of three agreement

| | | Uniform | Nonuniform | | |
|---|---|---|---|---|---|
| | Nonuniform | and | and | Uniform and | |
| Diagnosis | and changed | changed | not changed | not changed | Total |
| Melanoma | 12 | 3 | 1 | 0 | 16 |
| Severe | 15 | 8 | 4 | 0 | 27 |
| Other | 50 | 47 | 16 | 13 | 126 |
| Total | 77 | 58 | 21 | 13 | 169 |

This study was based on a highly selected group of lesions for which there was a significant element of concern largely on the basis of clinical features and change noted compared with baseline photos by the clinic physician. No nonuniform and changing lesion was left on a patient. In contrast, nevi not thought to be melanoma on the initial visit and lacking change, even if nonuniform, were not regularly excised. In young adults, there is a high prevalence of newly acquired nevi (Gallagher et al., Dermatol Clin 1995; 13:595-603). These lesions were also not regularly excised unless there was some additional worrisome feature (patient concern, dissimilar from patient's average mole types, or not clearly benign dermoscopic pattern).”

In contrast to Grichnik, the inventors have found that detection of moles that are potentially associated with melanoma may be advantageous even if it is based on the detection of change over time without necessarily relating to nonuniformity of the mole. While relying solely on change may yield, as can be seen in Table II in Grichnik (above), a higher false positive rate compared to relying on both a change and non-nuniformity, it may overall be advantageous in detecting a higher number of melanoma cases. If both a change and nonuniformity are required, then statistically, as Grichnik himself shows, a number of melanoma cases may be missed and remain undiagnosed. Given the severity of melanoma and the risk it poses to the patient, the present application proposes that over-detection (that is often referred to as a “false positive” result) may be advantageous over under-detection (that is often referred to as a “false negative” result).

A similar approach for detection of melanoma is taken in James M. Grichnik, Total Body Photography: A Valid Approach for Improving Patient Care, Skin and Aging 15(2), 2007, incorporated herein by reference.

A system for detecting one or more moles that are potentially associated with melanoma, according to an embodiment, is adapted to assist in the diagnosis of melanoma. The system may include an imaging station adapted to record at least two temporally-distinct images of a mole. The imaging station may include one or more imaging devices adapted to record images of a portion of the patient's skin, up to essentially the entirety of the patient's skin surface.

The imaging station may be implemented in a hospital, a clinic and/or the like, or even embodied as an essentially portable imaging device adapted, for example, for home use. Additionally, it may be implemented as a photo booth aimed at providing the public with a mole monitoring service. The term “photo booth”, as referred to herein, may relate to any chamber allowing a person to be comfortably and privately photographed, without some or all of the person's clothes, by the imaging device(s). A photo booth may be situated in an essentially public place, such as a shopping mall, a gymnasium, a medical institution, and/or the like. A person interested in having his moles monitored may enter the photo booth and get photographed by one or more imaging devices. The system may further include an interface module connected to the imaging station and adapted to transmit the image(s) taken to a remote storage device which is capable of storing them privately and securely over time. The same person may return to the same or a different photo booth at a later time, such as months or years later, to take additional image(s) for comparison with the previous image(s).

The system may then compare the previous and current image(s) to detect one or more moles that are suspected to be associated with melanoma. Results of the comparison may be provided to the person essentially immediately, on-site, or at a later time—such as mailed to him. Additionally or alternatively, the results may be transmitted to the person's physician and/or his responsible medical institute.

In some embodiments, the system may be adapted to detect skin lesions other than moles. For example, it may be adapted to record at least two temporally-distinct images of any type of skin lesion and to compare the previous and current image(s), so as to enable a caregiver to determine if the lesion is potentially associated with a medically-significant phenomena or ailment. In the foregoing description, it is intended that the term “mole” be interpreted to include any type of such skin lesions.

The following description begins with a portrayal of a computerized algorithm adapted to detect one or more moles in a digital image and to compare detected moles across a plurality of temporally-distinct images. The description continues with illustrating a system for recordation of patient images, detection of moles potentially associated with melanoma, and reporting of the results. The description concludes with further options for using the system.

### A Computerized Algorithm

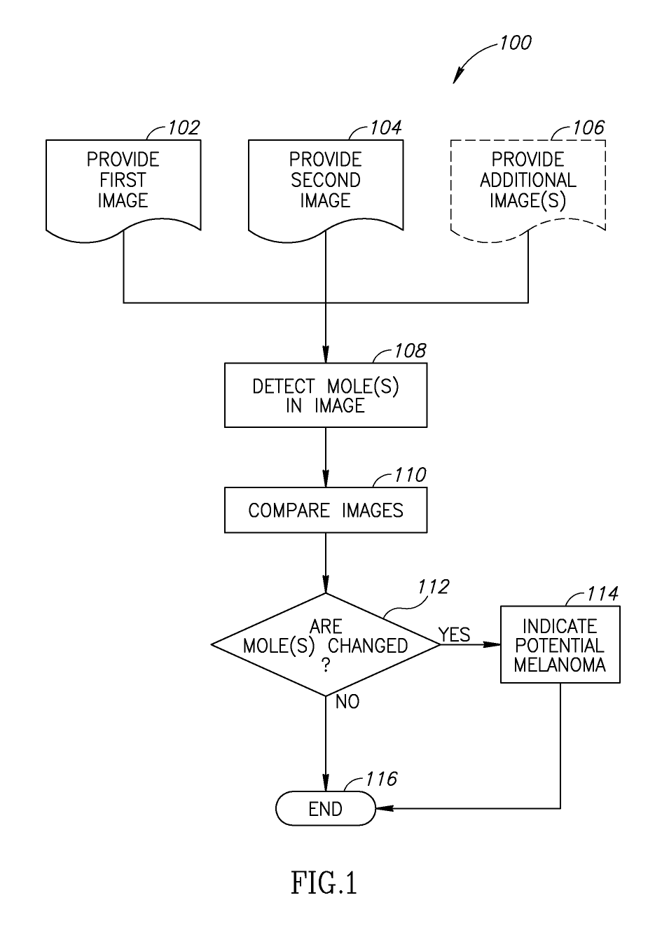

Reference is now made to FIG. 1, which shows a flow chart of an algorithm 100 for detecting one or more moles in two or more temporally-distinct digital images, and for comparing detected moles across the images. Algorithm 100 may also be referred to as a method 100.

In a block 102, a first image is provided. In a block 104, a second image is provided. In an optional block 106, one or more additional images may be provided. Images provided in blocks 102, 104 and optionally 106, are temporally-distinct, meaning—they were each taken at a different time. Each of the images provided in blocks 102, 104 and optionally 106, show at least one mole—the same mole—as it was recorded at different points in time.

Optionally, the images provided have a resolution of at least 1500 pixels per square centimeter (cm²). If the images are square, for example, this means they may have a width of \sqrt{1500} pixels and a height of \sqrt{1500} pixels.

In a block 108, the at least one mole is detected in each of the images. The detection of the at least one mole may include identifying which pixels in the digital image depict the mole and/or which pixels do not depict the mole and are, therefore, likely associated with skin and/or other elements. Detection of an object in a digital image is generally known in the art, and is considered part of the technology of computer vision. Computer vision is concerned with the theory of artificial systems that obtain information from images. In regard to mole detection, block 108 may include, for example, identification of the contrast between areas of the image, wherein darker areas represent mole(s) and lighter areas represent skin. Nonetheless, persons of skill in the art will recognize other common methods for detecting an object, such as a mole, in a digital image. See, for example, Nikos Paragios, Yunmei Chen & Olivier Faugeras, Handbook of Mathematical Models in Computer Vision (1st ed. 2005); and U.S. Pat. No. 6,993,167 to Skladnev et al., which disclose software able to automatically determine the skin/lesion border, both of which are incorporated herein by reference.

The detection of mole(s) in block 108 may be necessary for a following block 110, where the images are compared, since a comparison is needed only of the moles themselves, and not of the skin that surrounds them.

In addition, prior to the comparison of block 110, the images may be compensated for any viewing angle that may distort the ability to perform measurements of the mole in the images. Naturally, if the skin portion on which the mole exists is recorded while not being perpendicular to the imaging device, then any measurements performed on the image may be wrong. However, usage of three-dimensional imaging, as described above, may enable a determination of the mole's dimensions even in scenarios where it was not positioned perpendicular to the imaging device.

In block 110, the images are compared, with concentration on the mole(s) detected in them. The comparison may be performed for one or more parameters pertaining to the mole(s), to check for a difference in the parameter across the temporally-distinct images of the mole(s). A parameter may be, for example, the mole's location (or, even, the appearance of a new mole in a location previously clear of moles), its planar measurements, height above the skin, three-dimensional structure, color or the like. Basically, any visually-observable change in the mole over time may be included in the compared parameters. Any such change may be evidence of a malignant process in the mole. The malignant process of melanoma, as well as temporal changes in a mole that may be indicative of melanoma, are further discussed in Raymond L. Barnhill & M. J. Trotter, Pathology of Malignant Melanoma (1st ed. 2004); John F. Thompson, Donald L. Morton & Bin B. R. Kroon, Textbook of Melanoma: Pathology, Diagnosis and Management (1st ed. 2003); Guido Massi, Philip E. LeBoit, P. Pasquini, F. Federico, F. Castri & L. Celleno, Histological Diagnosis of Nevi and Melanoma (1st ed. 2004); and Michael Piepkorn, Klaus J. Busam & Raymond L. Barnhill, Pathology of Melanocytic Nevi and Malignant Melanoma (2nd ed. 2004), all of which are incorporated herein by reference.

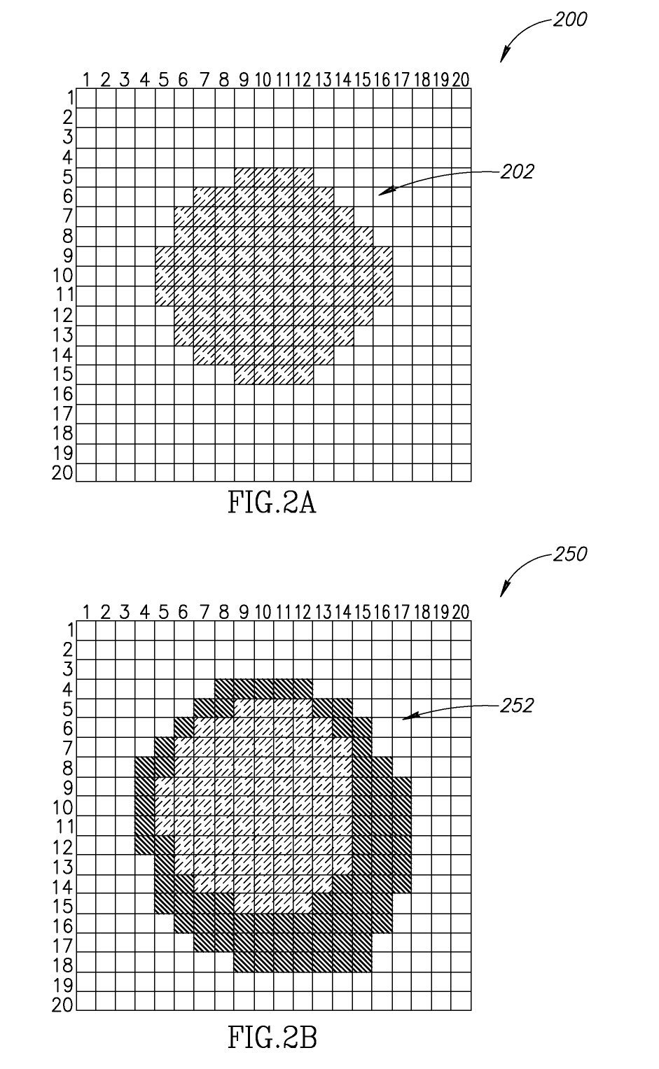

Reference is now made to FIG. 2A, which shows an exemplary first digital image 200 of a mole 202, and to FIG. 2B which shows an exemplary second digital image 250 of the same mole 252, recorded later. First image 200 and second image 250 are shown having a matrix which represents pixels. For simplicity of presentation, each of first image 200 and second image 250 is shown having 20 pixels over 20 pixels, for a total of 400 pixels. Pixels are referenced herein using their column number followed by their row number. For example, the pixel located in the leftmost column and in the bottom row of first image 200 is referred to as pixel (1,20).

Mole 202, which is part of an earlier-recorded image (first image 200), is shown having essentially a single color throughout its surface, the single color being depicted using diagonal, dashed hatching. Pixels lacking hatching, such as, for example, pixel (1,1), represent skin.

As shown in FIG. 2B, mole 252 is different than mole 202 in a number of parameters. First, mole 252 extends over a greater area, meaning its planar measurements have increased since first image 200 was recorded. For example, pixels (5,7) and (9,4) exceed the area previously occupied by mole 202. Second, the overall location of mole 252 is changed; it now extends more to the bottom and to the right compared with mole 202. Third, mole 252 changed its color during the time that had elapsed since first image 200 was recorded. The change in color is seen in the areas where mole 252 grew larger, such as, for example, in pixels (5,7) and (9,4) which are shown with a different hatching. In addition, the change in color is seen in areas previously having a different color, such as, for example, pixels (15,8-19) and (16,9-11) which are shown with one type of hatching in first image 200 and with a different type of hatching in second image 250. It should be noted that the term “color” may also refer to any change in a shade of color; for example, an essentially medium-brown mole whose shade is changed to dark-brown, may be referred to as a mole which underwent a color change.

Any one of the parameters in which mole 202 was changed over time, namely—planar measurements (size), location and color, may be indicative of the fact the mole is potentially associated with melanoma.

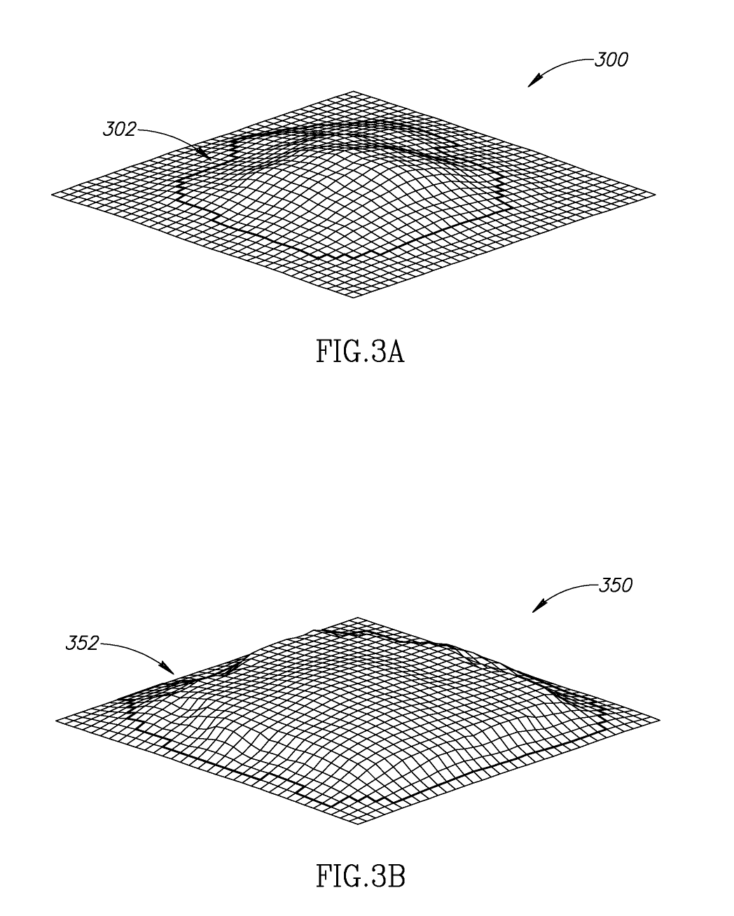

Reference is now made to FIG. 3A, which shows an exemplary first three-dimensional (3D) model 300 of a mole 302 shown surrounded by a thick line, and to FIG. 3B which shows an exemplary second 3D model 350 of the same mole 352 shown surrounded by a thick line, but recorded later. FIGS. 3A and 3B demonstrate a capability of algorithm 100 (FIG. 1) to compare temporally-distinct images which are essentially 3D models of a mole.

As shown in FIG. 3B, mole 352 is different than mole 302 in a number of parameters. First, mole 352 extends over a greater area, meaning its planar measurements have increased since first 3D model 300 was recorded. Second, as shown, a three-dimensional structure of mole 352 is different than a three-dimensional structure of mole 302. The difference in the three-dimensional structure is exhibited in a same location having a different (lower or higher) height above the skin. Multiple such locations are shown.

Any one of the parameters in which mole 302 was changed over time, namely-size and three-dimensional structure, may be indicative of the fact the mole is potentially associated with melanoma.

Referring back to FIG. 1, in a block 112, it is determined whether the compared moles are changed or not, across any of the parameters mentioned above. If no difference is apparent during the comparison of block 110, algorithm 100 may end in a block 116. If, on the other hand, a change in one or more parameters is discovered in block 110, algorithm 100 may indicate, in a block 114, a potential melanoma.

It may also be possible to perform pattern comparison of a portion of the skin containing at least one mole or other skin features. Such comparison may indicate a general pattern change rather than a change in a specific mole. For the purpose of such comparison, a viewing angle of the skin portion may be compensated, as discussed above. Furthermore, issues such as skin elasticity that causes temporal changes to its surface (and may affect location of the moles) may be compensated.

### A System

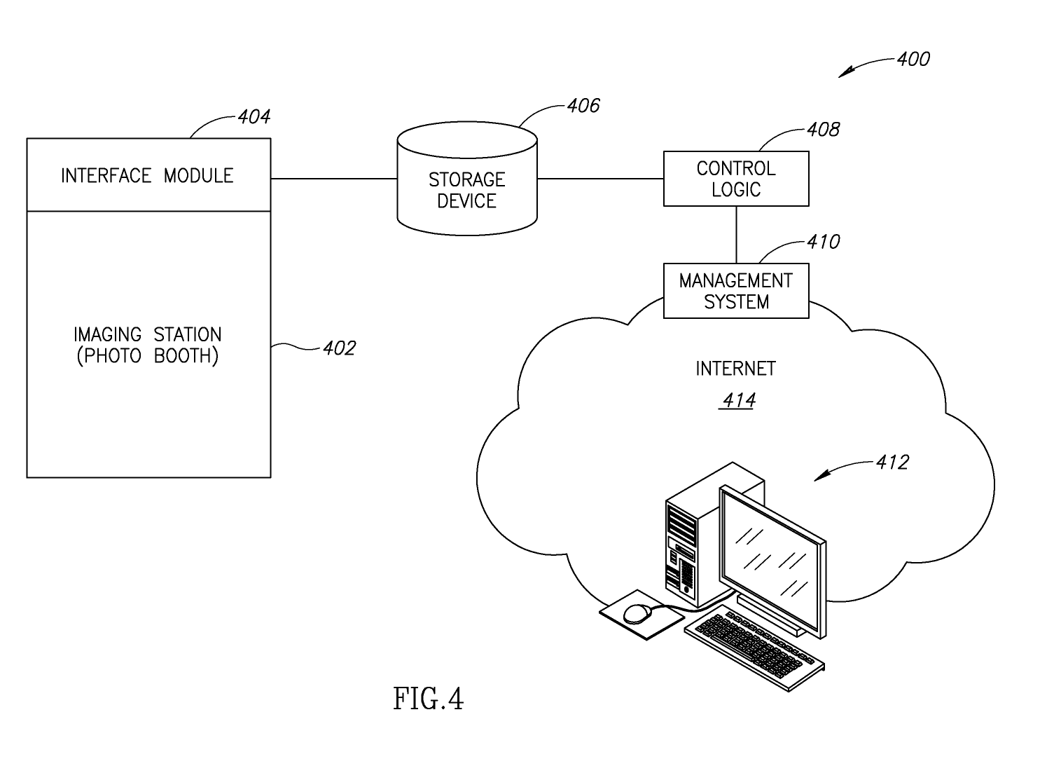

Algorithm 100 may be implemented in a system adapted to assist in the diagnosis of melanoma. Reference is now made to FIG. 4, which shows a network diagram of such a system 400. System 400 may include three key components: an imaging station 402, adapted to record two or more temporally-distinct images of a patient, a storage device 406, adapted to store the recorded images, and control logic 408, adapted to compare the images in order to detect mole(s) potentially associated with melanoma.

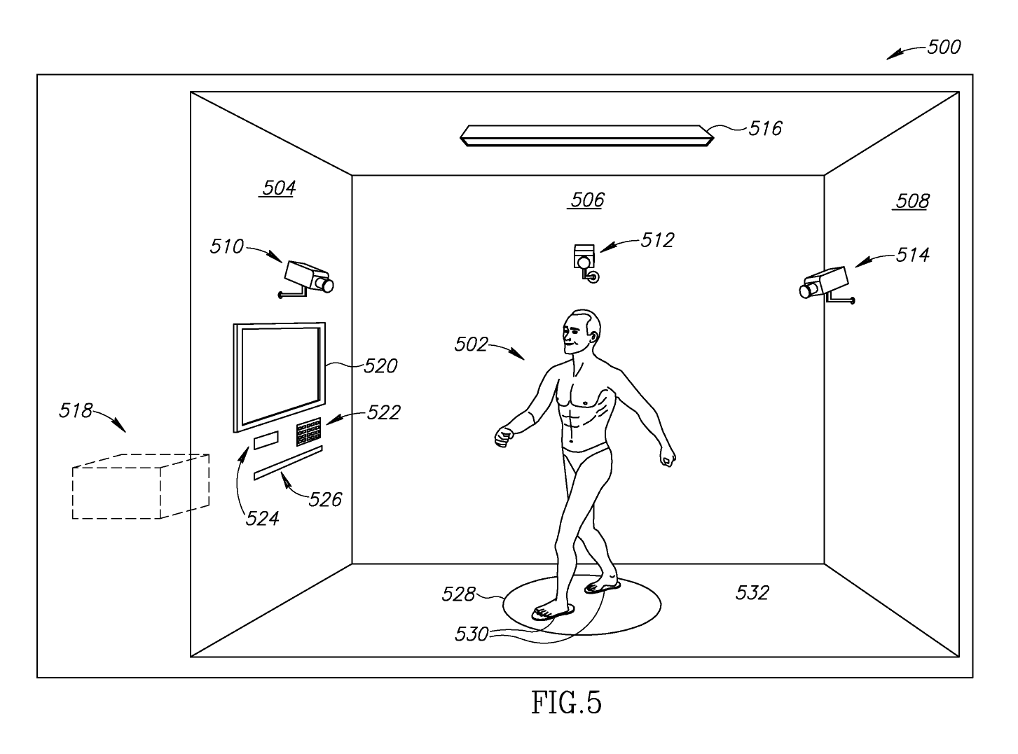

Imaging station 402 may include, as noted, a photo booth or any other means for recording an image of a person's skin. Referring now to FIG. 5, an exemplary photo booth 500 is shown. Persons of skill in the art will recognize that photo booth 500 is given only as an example, and an embodiment may well include a photo booth structured differently.

Photo booth 500 may be structured as a chamber of a size large enough to accommodate a person (also referred to as a “patient”) 502, while allowing enough distance between the person and walls 504, 506 and 508 of the photo booth so that an image of the person may be recorded effectively. Photo booth 500 is shown as a rectangular chamber, but may be structured to have any suitable form.

One or more imaging devices 510, 512 and 514 may be affixed to walls 504, 506 and 508, respectively. Those of skill in the art will recognize that a different number of imaging devices, positions of the devices, and the like, may differ from what is shown here. The three imaging devices 510, 512 and 514 are shown for reasons of simplicity only. Imaging devices 510, 512 and 514 may be equipped with optical zoom for lossless magnification of a photographed area of the patient's skin.

In a different embodiment (not shown), one or more imaging devices may be affixed to a movable apparatus adapted to rotate, ascend, descend and/or tilt around patient 502 for recording images of the patient from multiple angles.

Imaging devices 510, 512 and 514, as well as other, non-shown imaging devices, may be adapted to record a plurality of digital images covering a portion, up to the entirety of the patient's visible skin surface. As is well known in the art, skin areas most prone to be affected with malignant moles are those areas which are exposed to sunlight regularly. These areas are usually the arms, the neck, the scruff, the face and the like, as well as areas commonly exposed during beach and swimming pool activity, such as the back, the stomach and chest, the legs, and the like. Such areas may be given a priority when images are recorded, namely—patient 502 may be advised to let system 500 record images of at least some of these areas for effective diagnosis. However, since melanoma may also develop in hidden parts of the body, such as between the fingers and the toes, at the underarm, foot soles, under the breasts and/or the like, system 500 may request the patient's cooperation in exposing these area to the imaging device so that they can be recorded.

One or more illumination devices (not shown) may accompany imaging devices 510, 512 and 514 for providing light when images are recorded. Such illumination devices may be, for example, visible light flashes, infrared flashes, cross polarized light or even conventional lighting fixtures such as a lighting fixture 516.

Photo booth 500 may be further equipped with a control unit 518, a computerized device adapted to control and operate the photo booth. Control unit 518 may have connected to it a display 520, an input mechanism such as a keypad 522, a pointing device (not shown), a credit card swiping mechanism 524, a printer (not shown) and a printout opening 526, and/or the like. These features are optional; photo booth 500 may not include one or more of them.

Patient 502 may enter photo booth 500 and use keypad 522 and/or display 520 (if the display is of a touch-screen type) for interacting with control unit 518. Patient 502 may be requested to provide his personal details, such as his name, ID number, address and/or the like. Patient 502 may be further requested to provide demographic information, such his or hers place of birth, ethnicity, place of residence, lifestyle habits like sun bathing, tanning saloon usage, hiking and/or the like. Patient 502 may be further requested to provide payment for a service that may include recording of images, storage, comparison of temporally-distinct images for detection of moles potentially associated with melanoma, and/or the like. Payment may be provided by swiping a credit card in credit card swiping mechanism 524, or using any other payment method known in the art.

Patient 502 may receive instructions, vocally or visually, from control unit 518, during image recordation. These instructions may include, for example, requests to move around photo booth 500, change posture, turn around, and/or the like.

Alternatively, photo booth 500 may be operated by a trained human operator who may handle registration of the patient, billing and instruction of the patient during image recordation.

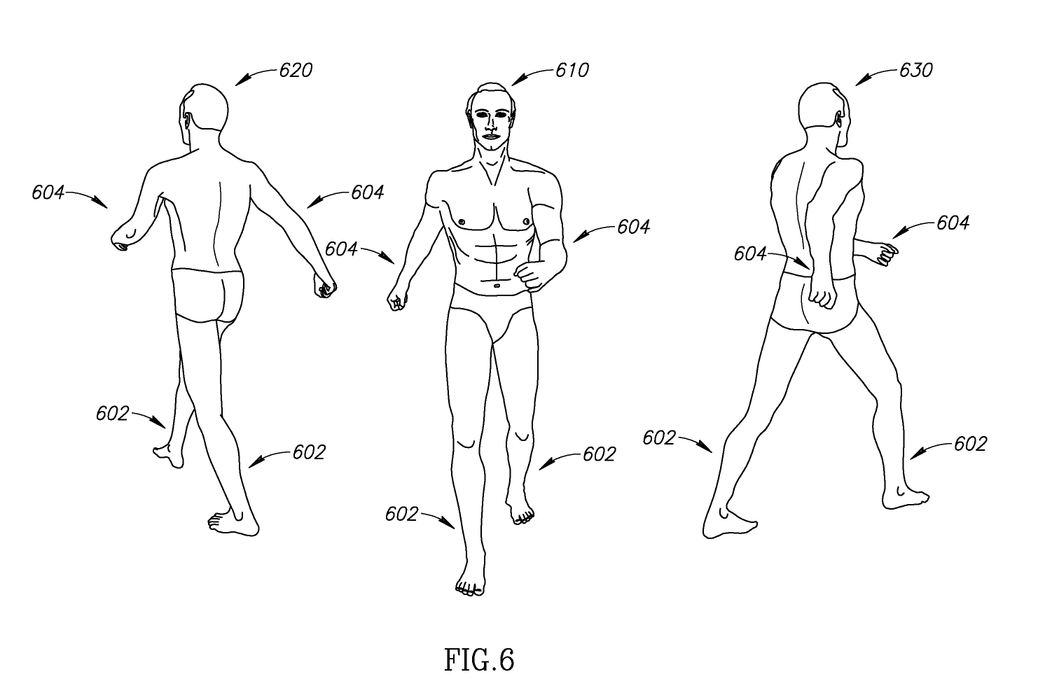

For recordation of images in photo booth 500, patient 502 may be requested to stand in such a posture that a majority of his skin surface is visible to one or more of imaging devices 510, 512 and 514, as well as to other, non-shown imaging devices, if such exist. Reference is now made to FIG. 6, which shows a perspective view of patient 502 (FIG. 5) from a front angle 610, from a back-left angle 620 and from a back-right angle 630. The posture in which the patient is shown includes straddled legs 602 and arms 604, extended away from the body, backward and forward. The posture shown in this figure is an example only. The patient may be requested to stand in a different posture or even to change posture periodically during image recordation.

In addition, the patient may be requested to mark portions of his body with color stickers used by the imaging devices for calibration purposes.

Referring now back to FIG. 5, a turntable 528 may be provided in a floor 532 of photo booth 500. Turntable 528 may include feet niches 530 for guiding and assisting the patient in standing in the requested posture, such as the posture shown in FIG. 6. Base 528 may include a motor (not shown) capable of rotating it for enabling recordation of images from different angles. The motor may be controlled by control unit 518. Additionally or alternatively, turntable 528 or a different fixture (not shown) may include hand rests (not shown) for also controlling the patient's hand positions. All fixtures aimed at controlling the patient's posture, such as turntable 528 and/or the hand rests fixture, may be jointly referred to as a “body positioning sub-system”.

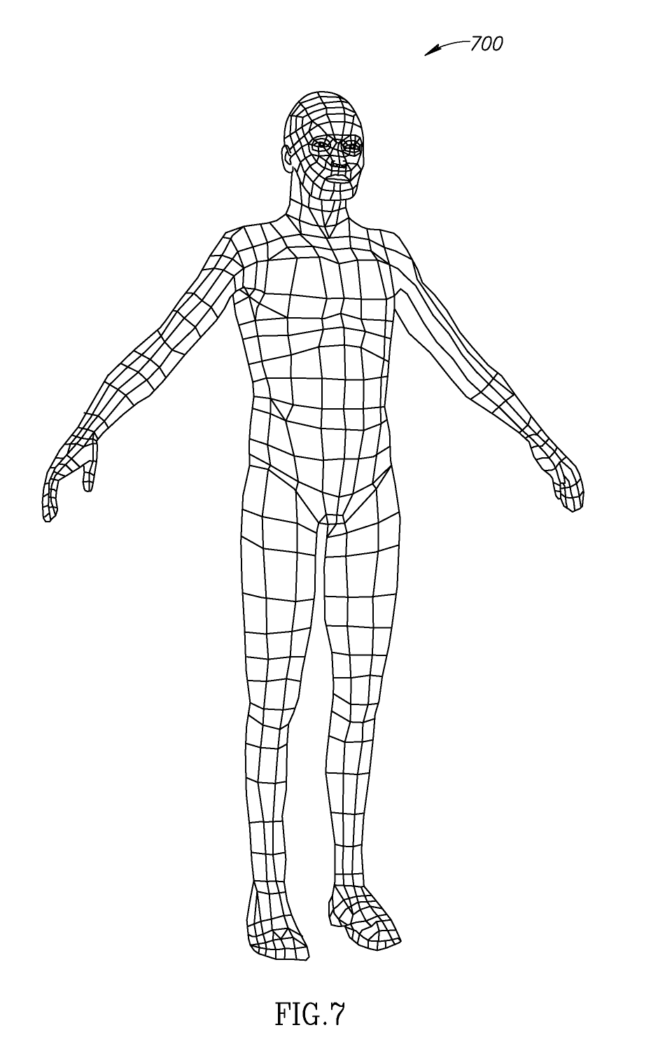

As to the recordation of images, photo booth 500 may operate as follows. Images may be recorded while imaging devices 510, 512 and 514, or some of them, are aimed at a same or a different location of the patient's body. Recordation of the same location from multiple angles (or at least having some overlap between the images) may enable the creation of a 3D model of a mole, as shown, for example, in FIGS. 3A-B. It may further enable the creation of a 3D model of the entire body of the patient. Such an exemplary full-body model is shown in FIG. 7, at 700.

Creation of a 3D model from a plurality of images usually involves a technique referred to as “triangulation”, where images from at least three angles of an object are processed to determine the object's 3D profile. Sometimes, rangefinders, such as lasers, are used to determine a distance between an imaging device and a target, and therefore assist in the triangulation. See, for example, U.S. Published Patent Application No. 2007/0076090 to Alexander, which discloses a device and method for producing a model of the surface of one aspect of a three dimensional object; U.S. Published Patent Application No. 2002/0048396 to Bewley et al., which discloses an apparatus and method for obtaining a data file representing a natural color three-dimensional image of the surface of a subject; and Wikipedia contributors, 3D scanner, Wikipedia, The Free Encyclopedia, http://en.wikipedia.org/w/index.php?title=3D_scanner&oldid=248303103 (accessed Nov. 3, 2008), all of which are incorporated herein by reference.

Overlapping between images may also enable the creation of a stitched image containing the entire body of the patient, or at least the entire body area covered by a combination of the images.

Another feature that may be used during the recordation of images is what is referred to in the art as “super resolution”. Super resolution is a method in which a number of low-resolution images are fused together to form a single, high-resolution image. Super resolution is further discussed, for example, in U.S. Pat. No. 7,003,177 to Mendlovic et al., entitled “Method and system for super resolution”; U.S. Pat. No. 7,428,019 to Irani et al., entitled “System and method for increasing space or time resolution in video”; U.S. Pat. No. 6,782,132 to Fogg, entitled “Video coding and reconstruction apparatus and methods”; and Sina Farsiu, M. Dirk Robinson, Micheal Elad, and Peyman Milanfar, “Fast and robust multiframe super resolution”, IEEE Trans. on Image Processing, Vol, 13, no. 10, October 2004, all of which are incorporated herein by reference. Accordingly, at least one of imaging devices 510, 512 and 514 may record a plurality of images of a same area of the patient's skin, for the purpose of fusing these images together to create a super resolution image.

Reference is now made back to FIG. 4. Imaging station 402, which may be photo booth 500 (FIG. 5), may include an interface module 404, adapted to transmit recorded images over a communication line. In photo booth 500 of FIG. 5, interface module 404 may be implemented inside control unit 518 or in connection with the control unit. Interface module 404 may include software adapted to transmit digital data such as images recorded by virtue of hardware, such as a modem, a network interface card, a router, and/or the like.

The data may be transmitted to a remote storage device 406. The term “remote” may refer to any location which is not inside or adjacent to imaging station 402. For example, remote storage device 406 may be located in a central location where data from a plurality of imaging stations 402 is collected. Aside from centralization, storing the data in a remote location may enhance security, since it may be easier to safeguard the data in one central location than in several scattered imaging stations 402. Multiple remote storage devices may exist, and may be distributed according to geographic areas, health care institutions and/or the like.

Storage device 406 may include a computerized device having a non-volatile memory. The computerized device may be adapted to receive data over a communication line from interface module 404 of imaging station 402. For this purpose, storage device 406 may include hardware, such as a modem, a network interface card, a router, and/or the like. Furthermore, storage device 406 may be implemented using a cloud computing methodology—a storage service provided via distributed resources.

Control logic 408 may be implemented as software in the computerized device of storage device 406, or in a different computerized device functionally connected to the storage device and adapted to fetch data from it. Control logic 408 may include algorithm 100 (FIG. 1), namely—it may be adapted to compare a parameter across at least two temporally-distinct images of a mole, and indicate, if a difference in the parameter is detected, that the mole is potentially associated with melanoma.

Prior to employing algorithm 100 (FIG. 1), control logic (or, alternatively, control unit 518 of FIG. 5) may perform pre-processing of one or more of the recorded images. Pre-processing may include two types of actions performed on the images: actions aimed at reducing file size and actions aimed at enhancing the images. For reducing file size, a background of the images may be removed (such as background not showing the patient), the files may be compressed using compression methods known in the art, and/or the colorspace of the files may be reduced. For enhancing the images, an image processing algorithm may be employed for hiding hair that may obstruct the view of moles, and/or for eliminating ambient light reflections that appear in the images. Artifacts such as hair and/or light reflection may be referred to as “noise”, while the mole itself may be referred to as a “signal”. Hence, elimination of the noise may improve the perceiving of the signal.

Hair and/or reflections may be eliminated, for example, using a technique often referred to as “stereoscopic imaging”. In stereoscopic imaging, two or more images of a same subject are taken from two or more different angles, and therefore, any artifacts (such as hair and/or reflections) in these images may appear in a slightly different location. Such a shift in location between the images may suggest that an artifact is encountered, and accordingly, “noise” pixels forming this artifact in one image may be substituted by “signal” pixels from the other image, and vice versa. At the end of this stereoscopic imaging process, a new image is constructed, having more signal pixels and less noise pixels than before, hence exposing more area of the photographed mole.

Further methods for elimination of artifacts in photographs are known in the art; some methods may be found, for example, in Salvador Gabarda et al., Cloud covering denoising through image fusion, Image and Vision Computing 25 (2007) 523-530; and Emilio Chuvieco et al., Assessment of multitemporal compositing techniques of MODIS and AVHRR images for burned land mapping, Remote Sensing of Environment 94 (2005) 450-462, all of which are incorporated herein by reference.

Practically, system 400 may be operated as follows. One or more imaging stations 402 may be positioned in places such as gyms, shopping malls, medical institutions and the like. A person interested in having his moles monitored may enter one of imaging stations 402 and get photographed. In his first visit to imaging station 402, the recorded images may be saved in storage device 406 as a reference. In a consecutive visit and any visit performed thereafter, newly-recorded images may be compared, by virtue of control logic 408, with older images.

The indication of control logic 408 about one or more moles that are potentially associated with melanoma, may be delivered to the patient, his physician, his attending medical institute, and/or the like. Delivery may be electronic, such as via email, or physical, such as via regular mail. Imaging system 402 may further provide the user with non-volatile media, such as a CD-ROM or a flash memory device, having the images and/or a report digitally embedded therein. In addition, a management system 410 may be connected to control logic 408 for the purpose of providing information regarding the mole monitoring to the patient, his physician, and/or the like. Management system 410 may include a web server having a website that enables secure access of the patient, his physician and/or the like for viewing data. Management system 410 may be available for access via a global network such as the Internet 414, by clients such as a client computer 412 having a web browser. Authentication of client computer 412 may be via means known in the art, such as a username and a password or via biometric identification such as fingerprinting or even a face photograph taken by a camera connected to the client computer and compared with a face image stored in storage device 406.

From a business perspective, a business entity wishing to provide a mole monitoring service may franchise the right to operate imaging stations, such as photo booths. Franchisers may be responsible for day-to-day operation of the imaging stations, whereas the recorded images may be transmitted from the stations directly to a remote storage device controlled by the mole monitoring service, so that the data remains secure. Pre-processing of the images, as well as comparison of temporally-distinct images, may be performed by control logic held and operated by the mole monitoring service. Payment received from patients may be divided between the mole monitoring service and the franchiser, whether the franchiser performs the initial collection from the patient or the mole monitoring service does so.

### Data Security

Whole body images have the potential of being misused if reaching the wrong hands. Therefore, security measures may be implemented in system 400, both for preventing leakage of data and for mitigating the harmful effect if such data is finally leaked.

At a basic level, the patient may be provided with a mask, a piece of cloth and/or the like for covering at least a portion of his face, such as the eyes. That way, even if images leak, the harmful effect is mitigated since the patient in the image cannot be identified. Similarly, control unit 518 (FIG. 5) may be adapted to manipulate recorded images so as to conceal the patient's eyes and/or other portions of the face. Such a measure may also be implemented in control logic 408.

At a more sophisticated level, images showing the patient's head or face may be stored separately from images showing the same patient's body. Separation may be in terms of different files in a same storage device, different files in different storage devices, or even different files in different storage devices that are located in different physical locations. That way, if only images showing the face or only images showing the body are exposed, no substantial harm is done.

Association of face/head images with body images may be performed using a data unit containing identification of the files. This data unit may be stored separately from files and, optionally, detached from any computer network, so no network-based malicious activity may reach this information. In addition, all identifiable information such as face files, personal information data, billing information, demographic information and/or the like may be stored separately from the total body image data. This way, even if a malicious activity provides access to the total body photography data, there would essentially be no way to associate between the pieces. In addition, at least a few pixels may be removed from images of the face/head and/or from images of the body where these areas meet (such as around the neck area), so that if a non-authorized person manages to acquire all images, associating face/head images with body images may be difficult, if not impossible.

Personal details of the patients may also be stored separately, especially separate from the body images. They may be stored with the head/face images or even separate from them. Should the personal details not be available at the time data retrieval is requested, the patient may be photographed again, and his mole pattern may be matched with a similar pattern evident in the stored images, so the correct images may be retrieved.

### Further Uses

System 400 may be used for purposes other than mole monitoring. For example, a 3D model created by system 400 may be used for purposes such as virtual world avatars, virtual clothing models, body building mapping and/or the like.

A virtual world is a computer-based simulated environment intended for its users to inhabit and interact via avatars. These avatars are often depicted as three-dimensional graphical representations. A 3D model of a person created by system 400 may be used by that person as his avatar in a virtual world. The 3D model may be converted to a format recognizable by the virtual world specified by the person.

A virtual clothing model is a 3D model of a person, often used by online clothing stores for assisting the buyer in fitting clothes. Usually, the buyer is requested to characterize his build by choosing from a number of options. See, for example, U.S. Pat. No. 5,930,769 to Rose, which discloses selecting a body type and fashion category based on personal information, and selecting fashions from a plurality of clothes items based on the body type and fashion category. This patent is incorporated herein by reference. However, a 3D model created by system 400 may be advantageously used for that purpose. A person may have his 3D model created by system 400 and may then use it in online clothing stores for fitting clothes of the correct size, fashion style, and the like.

Bodybuilding is a process of maximizing muscle hypertrophy, namely, growth and increase of the size of muscle cells. Bodybuilders often spend a substantial amount of time in gyms. Therefore, an imaging station, such as imaging station 402, may be implemented, for example, in gyms, allowing bodybuilders to monitor their visible muscle hypertrophy periodically. That is, control logic 408 may be adapted to compare at least two temporally-distinct images of a bodybuilder and to indicate whether there is an increase, a decrease or a status-quo in muscle size. In addition, as mentioned above, system 400 may be capable for producing a 3D module of a bodybuilder, hence providing information about various bodybuilding features like torso circumference, arm circumference, chest circumference and/or the like.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

In the description and claims of the application, each of the words “comprise” “include” and “have”, and forms thereof, are not necessarily limited to members in a list with which the words may be associated.

1-35. (canceled)

36. A mole monitoring system, the system comprising:
an imaging station to record at least two temporally-distinct images of a mole, wherein said imaging station comprises an interface module to transmit said at least two images to a remote storage device; and
control logic to retrieve said at least two images from said remote storage device, to compare a parameter across said at least two images of said mole, and to determine a difference in the parameter which is indicative of the mole being potentially associated with melanoma;
wherein said remote storage device is to separately store a first image showing a head of a patient and a second image showing a body of said patient, wherein said head and said body are parts of said at least two temporally-distinct images of said patient.

37. The system of claim 36, wherein said first image showing the head of the patient and said second image showing the body of the patient are stored as two separate files in a same storage device.

38. The system of claim 36, wherein said first image showing the head of the patient and said second image showing the body of the patient are stored as two separate files in two separate storage devices.

39. The system of claim 36, wherein said first image showing the head of the patient and said second image showing the body of the patient are stored as two separate files in two separate storage devices which are located in two different physical locations.

40. The system of claim 36, wherein association data, which associates between the first image showing the head of the patient and the second image showing the body of the patient, is stored separately from said first image and from said second image and in a network-detached unit.

41. The system of claim 36, wherein said control logic is to pre-process at least one of said images by concealing hair shown in at least one of said images.

42. The system of claim 36, wherein said control logic is to pre-process at least one of said images by concealing a light reflection shown in at least one of said images.

43. The system of claim 36, wherein the parameter comprises a parameter selected from the group consisting of:
a location of the mole;
one or more planar measurements of the mole;
a three-dimensional structure of the mole;
a color of the mole.

44. The system of claim 36, wherein said imaging station comprises:
a chamber to accommodate a patient;
a body positioning sub-system;
an illumination device; and
an imaging device to record said at least two temporally-distinct images of said mole.

45. The system of claim 36, wherein said control logic is to stitch said at least two images; and wherein said control logic is to create a three-dimensional model of said mole.

46. A method of mole monitoring, the method comprising:
recording at least two temporally-distinct images of a mole;
transmitting said at least two images to a remote storage device;
retrieving said at least two images from said remote storage device;
comparing a parameter across said at least two images of said mole, to determine a difference in the parameter which is indicative of the mole being potentially associated with melanoma;
wherein the method comprises, separately storing in said remote storage a first image showing a head of a patient and a second image showing a body of said patient, wherein said head and said body are parts of said at least two temporally-distinct images of said patient.

47. The method of claim 46, wherein storing comprises:
storing as two separate files in a same storage device, said first image showing the head of the patient and said second image showing the body of the patient.

48. The method of claim 46, wherein storing comprises:
storing as two separate files in two separate storage devices, said first image showing the head of the patient and said second image showing the body of the patient.

49. The method of claim 46, wherein storing comprises:
storing as two separate files in two separate storage devices which are located in two different physical locations, said first image showing the head of the patient and said second image showing the body of the patient.

50. The method of claim 46, comprising:
storing association data, which associates between the first image showing the head of the patient and the second image showing the body of the patient, separately from said first image and from said second image and in a network-detached unit.

51. The method of claim 46, comprising:
pre-processing at least one of said images by concealing hair shown in at least one of said images.

52. The method of claim 46, comprising:
pre-processing at least one of said images by concealing a light reflection shown in at least one of said images.

53. The method of claim 46, wherein the parameter comprises a parameter selected from the group consisting of:
a location of the mole;
one or more planar measurements of the mole;
a three-dimensional structure of the mole;
a color of the mole.

54. The method of claim 46, comprising:
stitching said at least two images; and
creating a three-dimensional model of said mole.

55. A mole monitoring apparatus, the apparatus comprising:
an imaging station to record at least two temporally-distinct images of a mole, and to transmit said at least two images to a remote storage device; and
wherein said remote storage device is to separately store a first image showing a head of a patient and a second image showing a body of said patient, wherein said head and said body are parts of said at least two temporally-distinct images of said patient.
